(19) United States
(12) Patent Application Publication
(10) Pub. No.: US 2021/0078367 A1
(43) Pub. Date: Mar. 18, 2021

(54) Pneumatic Tire

(71) Applicant: The Yokohama Rubber Co., LTD., Minato-ku, Tokyo (JP)

(72) Inventor: Hitomi Chaya, Hiratsuka-shi, Kanagawa (JP)

(21) Appl. No.: 16/970,335

(22) PCT Filed: Feb. 12, 2019
(86) PCT No.: PCT/JP2019/004850

§ 371 Date: Aug. 14, 2020

(30) Foreign Application Priority Data
Feb. 14, 2018 (JP) 2018-024354

(51) Int. Cl. B60C 11/00; B60C 15/00; B60C 15/06; B60C 11/03; B60C 11/12

(52) U.S. Cl. CPC B60C 11/005; B60C 15/0027; B60C 15/0018; B60C 15/0603; B60C 2011/1254; B60C 11/1236; B60C 11/1204; B60C 2011/1213; B60C 11/0304

(57) ABSTRACT

In a pneumatic tire including a tread portion, a pair of side wall portions, and a pair of bead portions, a carcass layer is mounted between the bead portions, the tread portion has a multilayer structure including a cap tread rubber layer and an undertread rubber layer, and a snow traction index is 180 or more. A tread radius in a meridian cross-section of the tread portion falls within a range of from 80% to 140% of a tire outer diameter, a ground contact width of the tread portion falls within a range of from 66% to 83% of a tire cross-sectional width, and a height of a bead filler is 40% or less of a tire cross-sectional height.

### TECHNICAL FIELD

The present technology relates to a pneumatic tire suitable for use on icy and snowy roads and particularly relates to a pneumatic tire capable of improving braking performance on ice and reducing rolling resistance.

### BACKGROUND ART

In general, in a pneumatic tire for use on icy and snowy roads, which is exemplified by a studless tire, a plurality of longitudinal grooves extending in a tire circumferential direction and a plurality of lateral grooves extending in a tire lateral direction are formed in a tread portion, and a number of blocks are defined by those longitudinal grooves and lateral grooves. Further, a plurality of sipes are formed in each of the blocks.

The pneumatic tire as described above can exert excellent driving performance on ice and snow with the grooves and the sipes formed in the tread portion. In recent years, it has been further demanded to improve braking performance on ice.

Further, the pneumatic tire for use on icy and snowy roads adopts a multilayer structure including a cap tread rubber layer and an undertread rubber layer for the tread portion. In this case, the flexible cap tread rubber layer exerts followability with respect to a road surface, and at the same time, the undertread rubber layer functioning as a foundation contributes to improvement in steering stability (for example, see Japan Unexamined Patent Publication Nos. 2009-262646 and 2017-140936).

However, in general, a rubber composition forming the undertread rubber layer has high tan 6. Thus, when the undertread rubber layer is increased in thickness, rolling resistance is likely to be degraded. In view of this, even though rolling resistance is regarded as a minor problem for the pneumatic tire for use on icy and snowy roads in the related art, it has been demanded to reduce rolling resistance in recent years.

### SUMMARY

The present technology provides a pneumatic tire capable of improving braking performance on ice and reducing rolling resistance.

A pneumatic tire according to the present technology includes: a tread portion extending in a tire circumferential direction and having an annular shape, a pair of sidewall portions disposed on both sides of the tread portion, and a pair of bead portions disposed inward of the pair of sidewall portions in a tire radial direction, wherein a carcass layer is mounted between the pair of bead portions, the tread portion has a multilayer structure including a cap tread rubber layer and an undertread rubber layer, grooves and sipes are formed in the tread portion, a snow traction index STI based on the grooves and sipes is 180 or more, a tread radius in a meridian cross-section of the tread portion falls within a range of from 80% to 140% of a tire outer diameter, a ground contact width of the tread portion falls within a range of from 66% to 83% of a tire cross-sectional width, and a height of a bead filler disposed on an outer circumference of a bead core of each of the pair of bead portions is 40% or less of a tire cross-sectional height.

In the present technology, a flat tread profile is adopted, and the ground contact width of the tread portion is increased. With this, a ground contact area of the tread portion can be increased, and braking performance on ice can be improved. Moreover, the height of the bead filler is reduced. With this, a vertical spring constant of the tire is reduced, and the side wall portion is likely to be deflected. Thus, an energy loss in the tread portion can be relatively reduced, and rolling resistance can be reduced. Further, when deflection of the side wall portion is promoted, a ground contact area at the time of braking is increased. Thus, this also contributes to improvement in braking performance on ice. With this, braking performance on ice can be improved, and rolling resistance can be reduced.

In the present technology, a tire maximum width position preferably falls within a range of from 50% to 60% of the tire cross-sectional height. When the tire maximum width position is set within the range, a vertical spring constant of the tire is reduced, and the side wall portion is likely to be deflected. Thus, an energy loss in the tread portion can be relatively reduced, and rolling resistance can be reduced. Further, deflection of the sidewall portion increases a ground contact area.

A rubber thickness at the tire maximum width position on an outer side of the carcass layer preferably falls within a range of from 1 mm to 4 mm. When the rubber thickness at the tire maximum width position on the outer side of the carcass layer is reduced, a vertical spring constant of the tire is reduced, and a ground contact area is increased. Further, an energy loss in the side wall portion can be reduced, and rolling resistance can be reduced.

The carcass layer is preferably turned up around the bead core from an inner side to an outer side of the tire, and a turned-up height of the carcass layer falls within a range of from 10% to 40% of the tire cross-sectional height. When the turned-up height of the carcass layer is reduced as described above, a vertical spring constant of the tire can be reduced, a ground contact area can be increased, and rolling resistance can be reduced.

In the present technology, in order to satisfy required characteristics as a pneumatic tire for use on icy and snowy roads, a snow traction index STI is set to 180 or more. The snow traction index STI is calculated with Expression (1) given below.

STI=−6.8+2202ρg+672ρs+7.6Dg (1)

Where

ρg: groove density (mm/mm²)=a total length of extending components of the grooves in the tire lateral direction (mm)/a total area of a ground contact region (mm²),

ρs: sipe density (mm/mm²)=a total length of extending components of the sipes in the tire lateral direction (mm)/a total area of a ground contact region (mm²), and

Dg: Average groove depth (mm).

In the present technology, the dimensions such as the tread radius, the tire outer diameter, and the tire cross-sectional height are measured under a state in which the tire is mounted on a regular rim and inflated to a regular internal pressure. Further, the tire ground contact width of the tread portion is the ground contact width in the tire axial direction measured under a state in which the tire is mounted on a regular rim and inflated to a regular internal pressure and when placed vertically upon a flat surface with a regular load applied thereto. “Regular rim” is a rim defined by a standard for each tire according to a system of standards that includes standards on which tires are based and refers to a “standard rim” in the case of JATMA (The Japan Automobile Tyre Manufacturers Association, Inc.), refers to a “design rim” in the case of TRA (The Tire and Rim Association, Inc.), and refers to a “measuring rim” in the case of ETRTO (The European Tyre and Rim Technical Organisation). “Regular internal pressure” is air pressure defined by a standard for each tire according to a system of standards that includes standards on which tires are based and refers to “maximum air pressure” in the case of JATMA, refers to the maximum value in the table of “TIRE ROAD LIMITS AT VARIOUS COLD INFLATION PRESSURES” in the case of TRA, and refers to “INFLATION PRESSURE” in the case of ETRTO. However, “regular internal pressure” is 180 kPa in a case where a tire is a tire for a passenger vehicle. “Regular load” is a load defined by a standard for each tire according to a system of standards that includes standards on which the tires are based and refers to “maximum load capacity” in the case of JATMA, refers to the maximum value in the table of “TIRE ROAD LIMITS AT VARIOUS COLD INFLATION PRESSURES” in the case of TRA, and refers to “LOAD CAPACITY” in the case of ETRTO. When the tire is for use with a passenger vehicle, a load corresponding to 88% of the load described above is used.

### BRIEF DESCRIPTION OF DRAWINGS

FIG. 1 is a meridian cross-sectional view illustrating a pneumatic tire according to an embodiment of the present technology.

FIG. 2 is a developed view illustrating a tread pattern of the pneumatic tire in FIG. 1.

### DETAILED DESCRIPTION

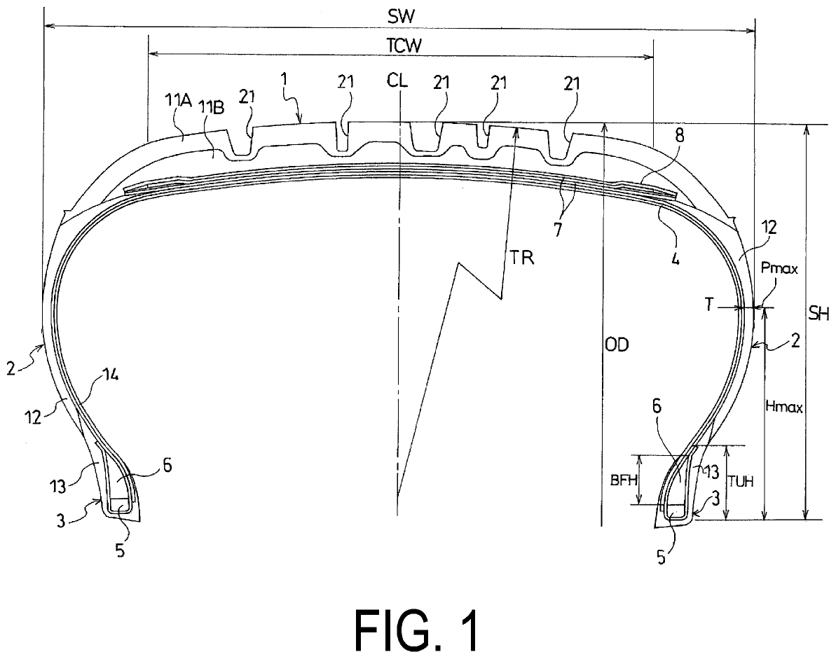

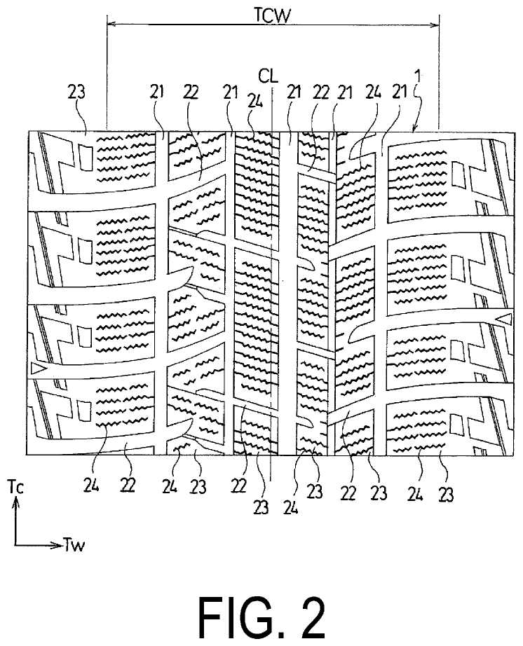

Configurations of embodiments of the present technology will be described in detail below with reference to the accompanying drawings. FIG. 1 and FIG. 2 illustrate a pneumatic tire according to an embodiment of the present technology. In FIG. 1 and FIG. 2, Tc indicates a tire circumferential direction, Tw indicates a tire lateral direction, CL indicates a tire equator, and TCW indicates a ground contact width.

As illustrated in FIG. 1, a pneumatic tire of the present embodiment includes a tread portion 1 having an annular shape and extending in the tire circumferential direction, a pair of sidewall portions 2, 2 disposed on both sides of the tread portion 1, and a pair of bead portions 3, 3 disposed inward of the sidewall portions 2 in the tire radial direction.

A carcass layer 4 is mounted between the pair of bead portions 3, 3. The carcass layer 4 includes a plurality of reinforcing cords extending in the tire radial direction and is folded back around bead cores 5 disposed in each of the bead portions 3 from a tire inner side to a tire outer side. A bead filler 6 having a triangular cross-sectional shape formed from rubber composition is disposed on the outer circumference of the bead core 5.

A plurality of belt layers 7 are embedded on the outer circumferential side of the carcass layer 4 in the tread portion 1. The belt layers 7 each include a plurality of reinforcing cords that are inclined with respect to the tire circumferential direction, the reinforcing cords being disposed between layers in a criss-cross manner. In the belt layers 7, the inclination angle of the reinforcing cords with respect to the tire circumferential direction falls within a range of from 10° to 40°, for example. Steel cords are preferably used as the reinforcing cords of the belt layers 7. To improve high-speed durability, at least one belt cover layer 8, formed by arranging reinforcing cords at an angle of, for example, not greater than 5° with respect to the tire circumferential direction, is disposed on an outer circumferential side of the belt layers 7. Nylon, aramid, or similar organic fiber cords are preferably used as the reinforcing cords of the belt cover layer 8.

In the pneumatic tire, a cap tread rubber layer 11A and an undertread rubber layer 11B are disposed on an outer side of the carcass layer 4, the belt layers 7, and the belt cover layer 8 in the tread portion 1. The cap tread rubber layer 11A is positioned outward of the undertread rubber layer 11B in the tire radial direction and is exposed to a tire outer surface. The undertread rubber layer 11B is formed of a rubber composition having hardness higher than a rubber composition forming the cap tread rubber layer 11A. More specifically, the rubber composition forming the cap tread rubber layer 11A has JIS hardness falling within a range of from 50 to 65, and the rubber composition forming the undertread rubber layer 11B has JIS (Japanese Industrial Standard) hardness falling within a range of from 56 to 66. The JIS hardness is the durometer hardness measured in accordance with JIS K-6253 using a type A durometer and under a temperature of 20° C.

Further, a side rubber layer 12 is disposed on an outer side of the carcass layer 4 in the sidewall portion 2. A rim cushion rubber layer 13 is disposed on the outer side of the carcass layer 4 in the bead portion 3. Further, on a tire inner surface, an innerliner layer 14 is disposed along the carcass layer 4.

As illustrated in FIG. 2, a plurality of longitudinal grooves 21 extending in the tire circumferential direction Tc and a plurality of lateral grooves 22 extending in the tire lateral direction Tw are formed in the tread portion 1. A plurality of land portions 23 each having a block shape are defined by those longitudinal grooves 21 and lateral grooves 22 in the tread portion 1. Further, in each of the land portions 23, a plurality of sipes 24 extending in the tire lateral direction are formed. The sipe may extend in a zigzag shape or may extend linearly along the tire lateral direction. The sipe 24 has a groove width of approximately 1.5 mm or less. Note that the tread pattern is not particularly limited. In order to satisfy required characteristics as a pneumatic tire for use on icy and snowy roads, a snow traction index STI is set to 180 or more, more preferably, falls within a range of from 180 to 240.

In the pneumatic tire, as illustrated in FIG. 1, a tread radius TR in the meridian cross-section of the tread portion 1 is set to fall within a range of from 80% to 140% of a tire outer diameter OD, the ground contact width TCW of the tread portion 1 is set to fall within a range of from 66% to 83% of a tire cross-sectional width SW, and a height BFH of the bead filler 6 disposed on an outer circumference of the bead core 5 of the bead portion 3 is set to fall within a range of 40% or less of a tire cross-sectional height SH.

In the pneumatic tire described above, a flat tread profile defined by the tread radius TR is adopted, and the ground contact width TCW of the tread portion 1 is increased. With this, a ground contact area of the tread portion 1 can be increased, and braking performance on ice can be improved. Moreover, the height BFH of the bead filler 6 is reduced. With this, a vertical spring constant of the tire is reduced, and the side wall portion 2 is likely to be deflected. Thus, an energy loss in the tread portion 1 can be relatively reduced, and rolling resistance can be reduced. Further, when the deflection of the side wall portion 2 is promoted, a ground contact area at the time of braking is increased. Thus, this also contributes to improvement in braking performance on ice. With this, braking performance on ice can be improved, and rolling resistance can be reduced.

Here, when the tread radius TR in the meridian cross-section of the tread portion 1 is less than 80% of the tire outer diameter OD, a ground contact area is insufficient. In contrast, when the tread radius TR is more than 140%, contact with the ground in a center region is degraded. Thus, an effect of improving braking performance on ice is lowered. Particularly, the tread radius TR preferably falls within a range of from 110% to 130% of the tire outer diameter OD.

Further, when the ground contact width TCW of the tread portion 1 is less than 66% of the tire cross-sectional width SW, a ground contact area is insufficient. In contrast, when the ground contact width TCW is more than 83%, contact with the ground is improved in shoulder regions but degraded in the center region. Thus, an effect of improving braking performance on ice is lowered. Particularly, the ground contact width TCW of the tread portion 1 preferably falls within a range of from 70% to 80% of the tire cross-sectional width SW.

Further, when the height BFH of the bead filler 6 is more than 40% of the tire cross-sectional height SH, an effect of reducing rolling resistance cannot be obtained. Particularly, the height BFH of the bead filler 6 preferably falls within a range of from 10% to 20% of the tire cross-sectional height SH. Note that the height BFH of the bead filler 6 may be 0% of the tire cross-sectional height SH (that is, a structure without the bead filler 6).

In the pneumatic tire, a height H max from a bead heel position to a tire maximum width position P max in the tire radial direction preferably falls within a range of from 50% to 60% of the tire cross-sectional height SH. When the tire maximum width position P max is disposed within the range, a vertical spring constant of the tire is reduced, and the side wall portion 2 is likely to be deflected. Thus, an energy loss in the tread portion 1 can be relatively reduced, and rolling resistance can be reduced. Further, when the side wall portion 2 is deflected, a ground contact area can be increased. Here, when the tire maximum width position P max is positioned inward of a position corresponding to 50% of the tire cross-sectional height SH in the tire radial direction, an effect of reducing a vertical spring constant is lowered. In contrast, when the tire maximum width position P max is positioned outward of a position corresponding to 60% of the tire cross-sectional height SH in the tire radial direction, which is not suitable for the tire structure, durability is degraded. Particularly, the height H max from the bead heal position to the tire maximum width position P max in the tire radial direction preferably falls within a range of from 52% to 56% of the tire cross-sectional height SH. In the pneumatic tire, a rubber thickness T at the tire maximum width position P max on an outer side of the carcass layer 4 preferably falls within a range of from 1 mm to 4 mm. When the rubber thickness T at the tire maximum width position P max on the outer side of the carcass layer 4 is reduced, a vertical spring constant of the tire is reduced, and a ground contact area is increased. Further, an energy loss in the side wall portion 2 can be reduced, and rolling resistance can be reduced. Here, when the rubber thickness T is less than 1 mm, cut resistance is degraded. In contrast, when the rubber thickness T is more than 4 mm, an energy loss in the side wall portion 2 is increased. Particularly, the rubber thickness T preferably falls within a range of from 2 mm to 3 mm.

In the pneumatic tire, the carcass layer 4 is turned up around the bead core 5 from an inner side to an outer side of the tire, a turned-up height TUH of the carcass layer 4 falls within a range of from 10% to 40% of the tire cross-sectional height SH. When the turned-up height TUH of the carcass layer 4 is reduced as described above, a vertical spring constant of the tire can be reduced, a ground contact area can be increased, and rolling resistance can be reduced. Here, when the turned-up height TUH of the carcass layer 4 is less than 10% of the tire cross-sectional height SH, rigidity around the bead portion 3 is insufficient. In contrast, when the turned-up height TUH is more than 40%, an effect of reducing a vertical spring constant is lowered. Particularly, the turned-up height TUH of the carcass layer 4 preferably falls within a range of from 20% to 30% of the tire cross-sectional height SH.

### Example

In a pneumatic tire in which each of the tires had a tire size of 205/60 R16 and included: a tread portion, a pair of sidewall portions, and a pair of bead portions, in which a carcass layer was mounted between the pair of bead portions, and the tread portion had a multilayer structure including a cap tread rubber layer and an undertread rubber layer, and in which grooves and sipes are formed in the tread portion, and a snow traction index STI based on those grooves and sipes was set 186 or more, a ratio of the tread radius TR with respect to the tire outer diameter OD (TR/OD×100%), a ratio of the ground contact width TCW with respect to the tire cross-sectional width SW (TCW/SW×100%), a ratio of the bead filler height BFH with respect to the tire cross-sectional height SH (BFH/SH×100%), the height H max at the tire maximum width position P max with respect to the tire cross-sectional height SH (H max/SH×100%), the rubber thickness T at the tire maximum width position P max, and a ratio of the turned-up height TUH of the carcass layer with respect to the tire cross-sectional height SH (TUH/SH×100%) were set as shown in Table 1, and tires in Conventional Example, Examples 1 to 10, and Comparative Examples 1 to 4 were produced.

Braking performance on ice and rolling resistance for these test tires were evaluated according to the following test methods, and the results are shown in Table 1.

### Braking Performance on Ice:

Each of the test tires was assembled on a wheel with a rim size of 16×6.0 J, mounted on a front wheel drive vehicle having an engine displacement of 1500 cc, and inflated to an air pressure of 180 kPa. A braking distance was measured after performing ABS braking from a traveling condition at a speed of 20 km/h on a test course formed of an icy road surface under a load equivalent to two passengers. The evaluation results were expressed, using the reciprocal of the measured values, as index values with the value of the Conventional Example being defined as 100. Larger index values indicate superior braking performance on ice.

### Rolling Resistance:

Each of the test tires was assembled on a wheel having a rim size of 16×6.0 J, and mounted on a rolling resistance tester, and pre-running was performed for 30 minutes under a condition of an air pressure of 230 kPa, a load of 4.5 kN, and a speed of 80 km/h. Then, rolling resistance was measured under the same conditions. The evaluation results were expressed, using the reciprocal of the measurement values, as index values with the value of the Conventional Example being defined as 100. Higher index values indicate lower rolling resistance.

TABLE 1-1

| | Conven- | Compar- | | |
|---|---|---|---|---|
| | tional | ative | | |
| | Example | Example 1 | Example 1 | Example 2 |
| TR (mm) | 550 | 500 | 600 | 1200 |
| TCW/SW × 100% | 60 | 75 | 75 | 75 |
| BFH/SH × 100% | 30 | 15 | 15 | 15 |
| Hmax/SH × 100% | 45 | 45 | 45 | 45 |
| Rubber thickness | 5 | 5 | 5 | 5 |
| T (mm) | | | | |
| Gc/SH × 100% | 11 | 11 | 11 | 11 |
| Gc/SH × 100% | 11 | 11 | 11 | 11 |
| TUH/SH × 100% | 50 | 50 | 50 | 50 |
| Bead core structure | FIG. 1 | FIG. 1 | FIG. 1 | FIG. 1 |
| Braking performance | 100 | 100 | 102 | 105 |
| (index value) | | | | |
| Rolling resistance | 100 | 105 | 105 | 105 |
| (index value) | | | | |

TABLE 1-2

| | | Compar- | Compar- | |
|---|---|---|---|---|
| | | ative | ative | |
| | Example 3 | Example 2 | Example 3 | Example 4 |
| TR (mm) | 1700 | 1800 | 1200 | 1200 |
| TCW/SW × 100% | 75 | 75 | 55 | 60 |
| BFH/SH × 100% | 15 | 15 | 15 | 15 |
| Hmax/SH × 100% | 45 | 45 | 45 | 45 |
| Rubber thickness | 5 | 5 | 5 | 5 |
| T (mm) | | | | |
| Gc/SH × 100% | 11 | 11 | 11 | 11 |
| Gc/SH × 100% | 11 | 11 | 11 | 11 |
| TUH/SH × 100% | 50 | 50 | 50 | 50 |
| Bead core structure | FIG. 1 | FIG. 1 | FIG. 1 | FIG. 1 |
| Braking performance | 102 | 100 | 100 | 102 |
| (index value) | | | | |
| Rolling resistance | 105 | 105 | 105 | 105 |
| (index value) | | | | |

TABLE 1-3

| | | Comparative | | |
|---|---|---|---|---|
| | Example 5 | Example 4 | Example 6 | Example 7 |
| TR (mm) | 1200 | 1200 | 1200 | 1200 |
| TCW/SW × 100% | 90 | 95 | 75 | 75 |
| BFH/SH × 100% | 15 | 15 | 10 | 20 |
| Hmax/SH × 100% | 45 | 45 | 45 | 45 |
| Rubber thickness | 5 | 5 | 5 | 5 |
| T (mm) | | | | |
| Gc/SH × 100% | 11 | 11 | 11 | 11 |
| Gc/SH × 100% | 11 | 11 | 11 | 11 |
| TUH/SH × 100% | 50 | 50 | 50 | 50 |
| Bead core structure | FIG. 1 | FIG. 1 | FIG. 1 | FIG. 1 |
| Braking performance | 102 | 100 | 105 | 105 |
| (index value) | | | | |
| Rolling resistance | 105 | 105 | 108 | 104 |
| (index value) | | | | |

TABLE 1-4

| | Exam- | Exam- | Exam- | Exam- | Exam- |
|---|---|---|---|---|---|
| | ple 8 | ple 9 | ple 10 | ple 11 | ple 12 |
| TR (mm) | 1200 | 1200 | 1200 | 1200 | 1200 |
| TCW/SW × 100% | 75 | 75 | 75 | 75 | 75 |
| BFH/SH × 100% | 15 | 15 | 15 | 15 | 0 |
| Hmax/SH × 100% | 55 | 55 | 55 | 55 | 55 |
| Rubber thickness T (mm) | 5 | 3 | 3 | 3 | 3 |
| Gc/SH × 100% | 11 | 11 | 5 | 5 | 5 |
| Gc/SH × 100% | 11 | 11 | 5 | 5 | 5 |
| TUH/SH × 100% | 50 | 50 | 50 | 25 | 25 |
| Bead core structure | FIG. 1 | FIG. 1 | FIG. 1 | FIG. 1 | FIG. 2 |
| Braking performance | 108 | 110 | 115 | 118 | 120 |
| (index value) | | | | | |
| Rolling resistance | 107 | 110 | 112 | 115 | 117 |
| (index value) | | | | | |

As understood from Table 1, the tires in Examples 1 to 10 was capable of improving braking performance on ice and reducing rolling resistance as compared to Conventional Example. In contrast, the tires in Comparative Examples 1 to 4 did not satisfy the predetermined dimension requirements, and hence a sufficient effect of improving braking performance on ice could not be obtained.

1. A pneumatic tire, comprising:
a tread portion extending in a tire circumferential direction and having an annular shape;
a pair of sidewall portions disposed on both sides of the tread portion; and
a pair of bead portions disposed inward of the pair of sidewall portions in a tire radial direction, wherein
a carcass layer is mounted between the pair of bead portions,
the tread portion has a multilayer structure including a cap tread rubber layer and an undertread rubber layer,
grooves and sipes are formed in the tread portion,
a snow traction index based on the grooves and sipes is 180 or more,
a tread radius in a meridian cross-section of the tread portion falls within a range of from 80% to 140% of a tire outer diameter,
a ground contact width of the tread portion falls within a range of from 66% to 83% of a tire cross-sectional width, and
a height of a bead filler disposed on an outer circumference of a bead core of each of the pair of bead portions is 40% or less of a tire cross-sectional height.

2. The pneumatic tire according to claim 1, wherein a tire maximum width position falls within a range of from 50% to 60% of the tire cross-sectional height.

3. The pneumatic tire according to claim 1, wherein a rubber thickness at a tire maximum width position on an outer side of the carcass layer falls within a range of from 1 mm to 4 mm.

4. The pneumatic tire according to claim 1, wherein the carcass layer is turned up around the bead core from an inner side to an outer side of the pneumatic tire, and a turned-up height of the carcass layer falls within a range of from 10% to 40% of the tire cross-sectional height.

5. The pneumatic tire according to claim 2, wherein a rubber thickness at a tire maximum width position on an outer side of the carcass layer falls within a range of from 1 mm to 4 mm.

6. The pneumatic tire according to claim 5, wherein the carcass layer is turned up around the bead core from an inner side to an outer side of the pneumatic tire, and a turned-up height of the carcass layer falls within a range of from 10% to 40% of the tire cross-sectional height.
